(19) United States
(12) Patent Application Publication
(10) Pub. No.: US 2020/0117442 A1
(43) Pub. Date: Apr. 16, 2020

(54) METHOD, SYSTEM AND PROGRAM PRODUCT FOR MONITORING AND MANAGING EMERGENCY ALERT SYSTEM DEVICES

(71) Applicant: Digital Alert Systems, Inc., Lyndonville, NY (US)

(72) Inventor: William Guy ROBERTSON, Bradenton, FL (US)

(73) Assignee: Digital Alert Systems, Inc., Lyndonville, NY (US)

(21) Appl. No.: 16/156,974

(22) Filed: Oct. 10, 2018

(51) Int. Cl. G06F 8/656; G06F 11/30; G06F 11/20; G06F 9/54; G06F 21/57; G06F 21/10; G08B 27/00

(52) U.S. Cl. CPC G06F 8/656; G06F 11/3055; G06F 11/2033; G08B 27/005; G06F 21/572; G06F 21/105; G06F 9/542

(57) ABSTRACT

A method of monitoring and managing Emergency Alert System/Common Alerting Protocol (EAS/CAP) devices includes providing a system, the system including processor(s) in communication with memory(ies) storing instructions for execution by the processor(s), the instructions enabling the monitoring and assisting with managing EAS/CAP devices, monitoring by the system a status of the EAS/CAP devices, the status relating to configuration settings and updates to software and firmware for the EAS/CAP devices, aggregating by the system government required compliance logs for the EAS/CAP devices, resulting in aggregated compliance logs, generating report(s) regarding the EAS/CAP devices with assistance from the system, the report(s) including a consolidated compliance report for providing to government agency(ies), the consolidated compliance report including the aggregated compliance logs, and managing the configuration settings and updates to software and firmware for the EAS/CAP devices with assistance from the system.

### BACKGROUND OF THE INVENTION

### Technical Field

The present disclosure generally relates to Emergency Alert System (EAS) devices. More particularly, the present disclosure relates to monitoring and managing EAS devices.

### Background Information

Emergency Alert System (EAS) regulations and content distribution technologies continue to evolve—exposing an environment where upgrades and configuration management require near continuous attention. Add government (e.g., FCC) requirements continually being updated making compliance progressively more complex and, most importantly, organizations who fail or are unable to keep up face increasingly significant fines. Maintenance and compliance costs are non-trivial as any updates to an EAS device requires at a minimum, a virtual “visit” to each and every device, multiply this by the number of devices and even a simple change quickly becomes a large labor cost. Also, every access increases the opportunity for configuration errors further increasing costs and possible customer or regulator dissatisfaction. This level of attention takes specialized expertise requiring a much higher level of understanding across a number of departments; Engineering, Operations, IT Security, Compliance, and Legal, sometimes with multiple members of each department being held responsible for managing different aspects of EAS management and compliance. Allowing each group open access is not ideal.

Standard asset management systems or spreadsheets are woefully inadequate for managing active EAS devices since these methods are static and ‘disconnected’, unable to provide timely or mission critical information.

Thus, there is a need to reduce EAS costs and complexities, with the minimal amount of necessary staffing to perform all necessary functions.

### SUMMARY OF THE INVENTION

The shortcomings of the prior art are overcome and additional advantages are provided through the provision, in one aspect, of a method of monitoring and managing Emergency Alert System/Common Alerting Protocol (EAS/CAP) devices. The method comprises providing a system, the system comprising at least one processor in communication with at least one memory storing instructions for execution by the at least one processor, the instructions enabling monitoring and assisting with managing a plurality of EAS/CAP devices, and monitoring by the system a status of the plurality of EAS/CAP devices, the status relating to configuration settings and updates to software and firmware for the plurality of EAS/CAP devices. The method further comprises aggregating by the system government required compliance logs for the plurality of EAS/CAP devices, resulting in aggregated compliance logs, and generating one or more reports regarding the plurality of EAS/CAP devices with assistance from the system, wherein the one or more reports comprise a consolidated compliance report for providing to one or more government agencies, the consolidated compliance report comprising the aggregated compliance logs.

In accordance with another aspect, a system is provided for monitoring and managing Emergency Alert System/Common Alerting Protocol (EAS/CAP) devices, the system comprising at least one processor, and at least one memory in communication with the at least one processor, the at least one memory storing instructions for execution by the at least one processor, the instructions enabling a method of monitoring and assisting with managing a plurality of EAS/CAP devices, the at least one processor and the at least one memory with the instructions stored comprising a system. The method comprises monitoring by the system a status of the plurality of EAS/CAP devices, the status relating to configuration settings and updates to software and firmware for the plurality of EAS/CAP devices, aggregating by the system government required compliance logs for the plurality of EAS/CAP devices, resulting in aggregated compliance logs, and generating one or more reports regarding the plurality of EAS/CAP devices with assistance from the system, the one or more reports comprising a consolidated compliance report for providing to one or more government agencies, the consolidated compliance report comprising the aggregated compliance logs.

In accordance with yet another aspect, a computer program product is provided. The computer program product comprises a non-transitory storage medium readable by at least one processor, the non-transitory storage medium storing instructions for execution by the at least one processor for performing a method of monitoring and assisting with managing Emergency Alert System/Common Alerting Protocol (EAS/CAP) devices. The method comprises monitoring by the system a status of the plurality of EAS/CAP devices, the status relating to configuration settings and updates to software and firmware for the plurality of EAS/CAP devices, aggregating by the system government required compliance logs for the plurality of EAS/CAP devices, resulting in aggregated compliance logs, and generating one or more reports regarding the plurality of EAS/CAP devices with assistance from the system, wherein the one or more reports comprise a consolidated compliance report for providing to one or more government agencies, the consolidated compliance report comprising the aggregated compliance logs.

Additional features and advantages of this invention will become apparent from the following detailed description of the various aspects of the invention taken in conjunction with the accompanying drawings.

### BRIEF DESCRIPTION OF THE DRAWINGS

FIG. 1 is a modified flow diagram of one example of one or more EAS/CAP devices being linked to the Data Processing System and Database for storing device and management information of a data processing system for monitoring and managing EAS/CAP devices, in accordance with one or more aspects of the present disclosure.

FIG. 2 is a modified flow diagram of one example of the operation of an EAS/CAP Logging Module of the data processing system for monitoring and managing EAS/CAP devices, in accordance with one or more aspects of the present disclosure.

FIG. 3 is a modified flow diagram of one example of the operation of an Advanced Configuration Module, based on the EAS/CAP Logging Module of FIG. 2, of the data processing system for monitoring and managing EAS/CAP devices, in accordance with one or more aspects of the present disclosure.

FIG. 4 is a modified flow diagram of one example of the operation of an Advanced Reporting Module, based on the EAS/CAP Logging Module of FIG. 2, of the data processing system for monitoring and managing EAS/CAP devices, in accordance with one or more aspects of the present disclosure.

FIG. 5 is a modified flow diagram of one example of the operation of an Alarm Notification Module, based on the EAS/CAP Logging Module of FIG. 2, of the data processing system for monitoring and managing EAS/CAP devices, in accordance with one or more aspects of the present disclosure.

FIG. 6 is a modified flow diagram of one example of the operation of a Dashboard Viewer Module, based on the EAS/CAP Logging Module of FIG. 2, of the data processing system for monitoring and managing EAS/CAP devices, in accordance with one or more aspects of the present disclosure.

FIG. 7 is a modified flow diagram of one example of the operation of a License Key Module of the data processing system for monitoring and managing EAS/CAP devices, in accordance with one or more aspects of the present disclosure.

FIG. 8 is a modified flow diagram of one example of the operation of an Advanced Authentication Module of the data processing system for monitoring and managing EAS/CAP devices, in accordance with one or more aspects of the present disclosure.

FIG. 9 is a modified flow diagram of one example of a Redundancy Module of the data processing system for monitoring and managing EAS/CAP devices, in accordance with one or more aspects of the present disclosure.

FIG. 10 depicts one example of a computer program product storing program code logic, in accordance with one or more aspects of the present disclosure.

FIG. 11 depicts one example of a data processing system suitable for use with the present disclosure.

FIG. 12 is a modified flow diagram for one example of registering an EAS/CAP device with a data processing system for monitoring and managing EAS/CAP devices, in accordance with one or more aspects of the present disclosure.

### DETAILED DESCRIPTION OF THE INVENTION

The unique operational design herein and requirement for configuring and managing EAS/CAP devices requires a completely unique set of tools and processes which are embodied in this disclosure.

Aspects of the present disclosure and certain features, advantages, and details thereof, are explained more fully below with reference to the non-limiting examples illustrated in the accompanying drawings. Descriptions of well-known materials, fabrication tools, processing techniques, etc., are omitted so as not to unnecessarily obscure the invention in detail. It should be understood, however, that the detailed description and the specific examples, while indicating aspects of the invention, are given by way of illustration only, and are not by way of limitation. Various substitutions, modifications, additions, and/or arrangements, within the spirit and/or scope of the underlying inventive concepts will be apparent to those skilled in the art from this disclosure.

Approximating language, as used herein throughout the specification and claims, may be applied to modify any quantitative representation that could permissibly vary without resulting in a change in the basic function to which it is related. Accordingly, a value modified by a term or terms, such as “about,” is not limited to the precise value specified. In some instances, the approximating language may correspond to the precision of an instrument for measuring the value.

The terminology used herein is for the purpose of describing particular examples only and is not intended to be limiting of the invention. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include (and any form of include, such as “includes” and “including”), and “contain” (and any form of contain, such as “contains” and “containing”) are open-ended linking verbs. As a result, a method or device that “comprises,” “has,” “includes” or “contains” one or more steps or elements possesses those one or more steps or elements, but is not limited to possessing only those one or more steps or elements. Likewise, a step of a method or an element of a device that “comprises,” “has,” “includes” or “contains” one or more features possesses those one or more features, but is not limited to possessing only those one or more features. Furthermore, a device or structure that is configured in a certain way is configured in at least that way, but may also be configured in ways that are not listed.

As used herein, the term “EAS device(s)” or “EAS/CAP device(s)” or “CAP device(s)” includes Emergency Alert System (EAS) devices and Common Alerting Protocol (CAP) capable EAS devices. Further, the terms include EAS devices alone, CAP devices alone or a combination of EAS and CAP devices.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of“may” and “may be” indicates that a modified term is apparently appropriate, capable, or suitable for an indicated capacity, function, or usage, while taking into account that in some circumstances the modified term may sometimes not be appropriate, capable or suitable. For example, in some circumstances, an event or capacity can be expected, while in other circumstances the event or capacity cannot occur—this distinction is captured by the terms “may” and “may be.”

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable storage medium(s) having computer readable program code embodied thereon.

Spatially relative terms, such as “beneath,” “below,” “lower,” “above,” “upper,” and the like, may be used herein for ease of description to describe one element's or feature's relationship to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “below” or “beneath” other elements or features would then be oriented “above” or “over” the other elements or features. Thus, the exemplary term “below” may encompass both an orientation of above and below. The device may be otherwise oriented (e.g., rotated 90 degrees or at other orientations) and the spatially relative descriptors used herein should be interpreted accordingly. When the phrase “at least one of” is applied to a list, it is being applied to the entire list, and not to the individual members of the list.

A computer readable storage medium may be, for example, but not limited to, an electronic, magnetic, optical, electromagnetic, infrared or semiconductor system, apparatus, or device, or any suitable combination of the foregoing. More specific examples (a non-exhaustive list) of the computer readable storage medium include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, a decentralized storage system such as a blockchain implementation, or any suitable combination of the foregoing. In the context of this document, a computer readable storage medium may be any tangible medium that can contain or store a program for use by or in connection with an instruction execution system, apparatus, or device.

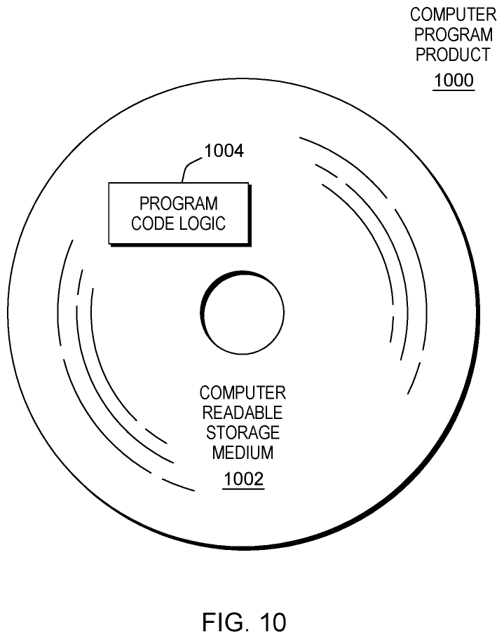

FIG. 10 depicts one example of a computer program product 1000, in this example, a non-transitory storage medium 1002, for example, a CD-ROM storing program code logic 1004 for monitoring and managing EAS/CAP devices, in accordance with one or more aspects of the present disclosure.

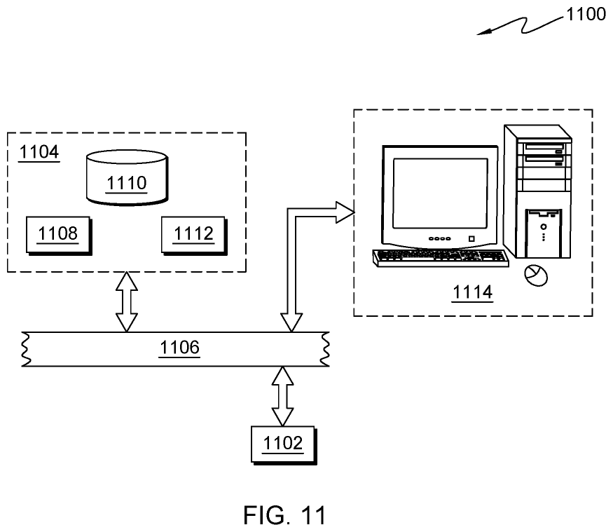

FIG. 11 depicts one example of a data processing system 1100 suitable for storing and/or executing program code for implementing the method of the present disclosure is usable that includes at least one processor 1102, coupled directly or indirectly to memory elements 1104 through a system bus 1106, communication with the system being done via, for example, one or more peripherals 1108 or other input/output types, in accordance with one or more aspects of the present disclosure.

Computer program code embodied on a computer readable storage medium may be transmitted using any appropriate technologies, including but not limited to, wireless, wireline, optical fiber cable, Bluetooth, RF, etc., or any suitable combination of the foregoing.

Computer program code for carrying out operations for aspects of the present disclosure may be written in any combination of one or more programming languages, including, for example, an object oriented programming language, such as, for example, JAVA, Smalltalk, C++ or the like, and conventional procedural programming languages, such as, for example, the “C” programming language, PHP programming language, Bash, HTML and/or JavaScript scripting languages, assembler or similar programming languages. The program code may execute, via one or more processors, entirely locally, entirely remotely, a combination of locally and remotely. In the latter scenario, the remote processor may be connected to the user's computer through any type of network, including a local area network (LAN) or a wide area network (WAN), or the connection may be made to an external processor (for example, through the Internet using an Internet Service Provider).

Aspects may be described herein with reference to flowchart illustrations and/or block diagrams of methods, apparatus (systems) and computer program products according to one or more embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Further, other types of computing environments can benefit from one or more aspects. As an example, an environment may include an emulator (e.g., software or other emulation mechanisms), in which a particular architecture (including, for instance, instruction execution, architected functions, such as address translation, and architected registers) or a subset thereof is emulated (e.g., on a native computer system having a processor and memory). In such an environment, one or more emulation functions of the emulator can implement one or more aspects, even though a computer executing the emulator may have a different architecture than the capabilities being emulated. As one example, in emulation mode, the specific instruction or operation being emulated is decoded, and an appropriate emulation function is built to implement the individual instruction or operation.

In an emulation environment, a host computer includes, for instance, a memory to store instructions and data; an instruction fetch unit to fetch instructions from memory and to optionally, provide local buffering for the fetched instruction; an instruction decode unit to receive the fetched instructions and to determine the type of instructions that have been fetched; and an instruction execution unit to execute the instructions. Execution may include loading data into a register from memory; storing data back to memory from a register; or performing some type of arithmetic or logical operation, as determined by the decode unit. In one example, each unit is implemented in software. For instance, the operations being performed by the units are implemented as one or more subroutines within emulator software.

One or more aspects herein may relate to cloud computing.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is service oriented with a focus on statelessness, low coupling, modularity, and semantic interoperability. At the heart of cloud computing is an infrastructure comprising a network of interconnected nodes.

Further, a data processing system suitable for storing and/or executing program code is usable that includes at least one processor coupled directly or indirectly to memory elements through a system bus. The memory elements include, for instance, local memory employed during actual execution of the program code, bulk storage, and cache memory which provide temporary storage of at least some program code in order to reduce the number of times code must be retrieved from bulk storage during execution.

Input/Output or I/O devices, including, but not limited to, keyboards, displays, pointing devices, DASD, tape, CDs, DVDs, thumb drives and other memory media, touch-screen based devices (e.g., laptop computers, mobile phones, tablets, smart watches, etc.), smart TVs, controllers for the TVs, set-top-box style streaming devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, Bluetooth, Wi-Fi, and Ethernet cards are just a few of the available types of network adapters.

The invention goes beyond simple EAS log-gathering to provide a far more comprehensive range of data from each device, including originated, decoded, and forwarded alerts; configuration changes; operational status; current software/hardware versions; and analog and digital monitoring data such as radio frequency, signal strength, and Common Alerting Protocol (CAP) inputs; among a vast amount of other summary detail required by the FCC. In so doing, the invention provides a far more complete picture of the EAS landscape and greater situational awareness of each device than ever before. Credentialed experts from various departments, such as engineering, compliance, legal, and management, can access this wealth of information in real time—information that otherwise could take days and numerous people to assemble using any other means.

The invention combines EAS operations and compliance under one umbrella for unified configuration control, EAS log reporting, and error/alarm monitoring.

The invention oversees the health and status of each EAS device, alerting key personnel of critical changes, centralizing the management of configuration settings, managing software updates, and consolidating FCC-mandated EAS test results.

The invention allows for proactively addressing any potential compliance or subscriber issues. For example, the FCC's Sixth Report and Order states that cable operators must report national EAS tests through the online EAS Test Reporting System (ETRS)—meaning participants must fill in at least 81 individual data fields for each EAS device in each national test. Consolidating this information from multiple locations is an incredibly time-consuming task, but the invention provides all the information within minutes of a test ending.

The invention increases security by accepting information only from those devices which meet specific criteria, thereby preventing alerts propagating without being properly vetted. Only those devices whose configurations and other settings deemed acceptable are able to submit alert information to the rest of the system and only those devices with proper license can communicate with the Core Module. Moreover, an operator can “push” updates such as software, device license keys, new or modified configurations, to units in the field, critical for quickly and efficiently replacing or restoring service without requiring a high level of knowledge at the local site—on-site personnel need merely connect and turn on the device—configuration is managed through the operator's expertise.

The invention is designed in a modular fashion so users can scale the perfect solution to fit their specific environment or needs and can be installed on stand-alone hardware or integrated into a large data center in virtual machine environments. Besides scalability, the invention supports redundancy with automatic failover.

Each of the optional modules provides a different view or level of interactivity to meet specific user's requirements. Everything works, in one example, via a secure IP connection between EAS devices and the Core Module, sending information when requested, or when necessary all through a comprehensive database. From this information the Core Module allows other modules to “act” on the data for sophisticated queries, searches, visual representations, geographic-based displays, and a host of other applications including those timely and critical FCC reports.

Commercially available EAS devices include those offered by, for example, Digital Alert Systems of Lyndonville, N.Y.

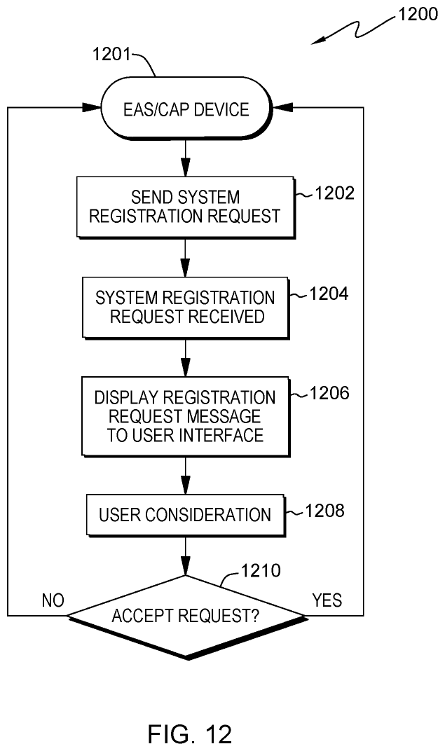

FIG. 12 is a modified flow diagram 1200 for one example of registering an EAS/CAP device with a data processing system, in accordance with one or more aspects of the present disclosure.

EAS/CAP device 1201 sends a Registration Request 1202 message to the data processing system received 1204. The data processing system indicates the presence of this request to the user interface 1206. The user considers 1208 the message and can either accept or reject the registration request, inquiry 1210, “accept request?”, which returns the Registration Accept/Reject 1210 message to the EAS/CAP device.

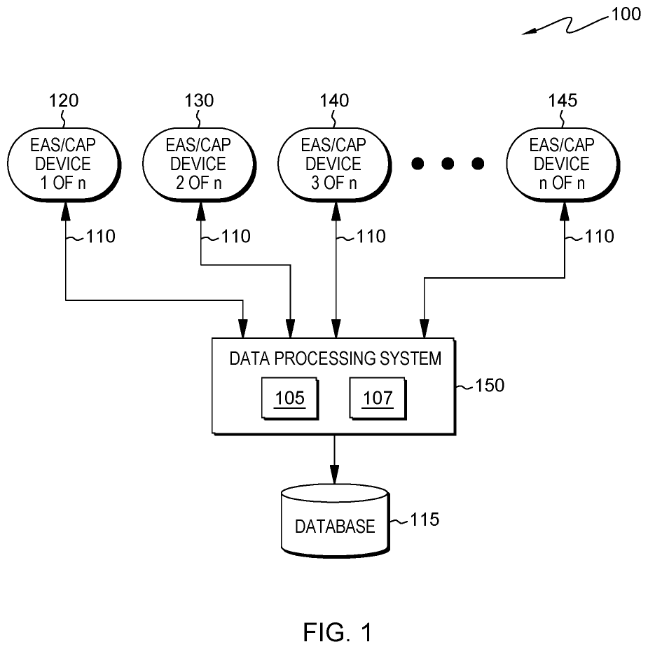

FIG. 1 is a modified flow diagram 100 of one example of operation of a Core Module 105 and Basic Configuration Module 107, as part of a data processing system 150 for monitoring and managing EAS devices, for example, EAS devices 120, 130, 140 and 145 (note, there could be more or fewer than shown in FIG. 1) over a bi-directional communication link 110, in accordance with one or more aspects of the present disclosure.

The Core Module, which, in one embodiment, requires the Basic Configuration Module, is the central point for EAS device communications, data storage, and connections to other modules. All data is stored in a highly-reliable database 115, for example, an SQL database, where users, permissions, and groups administration is performed through the simple user interface. The Core Module also serves as the secure communications connection point for the data exchanged between EAS devices. In one embodiment, the data processing system provides verbose logging and a unique ability to add a note to any event, which speeds troubleshooting tasks.

The Basic Configuration Module provides critical support for EAS operations by assuring the latest configuration settings are stored and readily retrievable streamlining initial setup or replacements and any configuration changes on an EAS device are automatically stored as a chronological list of configuration files. In combination with automated backups, users are assured the most current configurations for every EAS devices are saved and accessible.

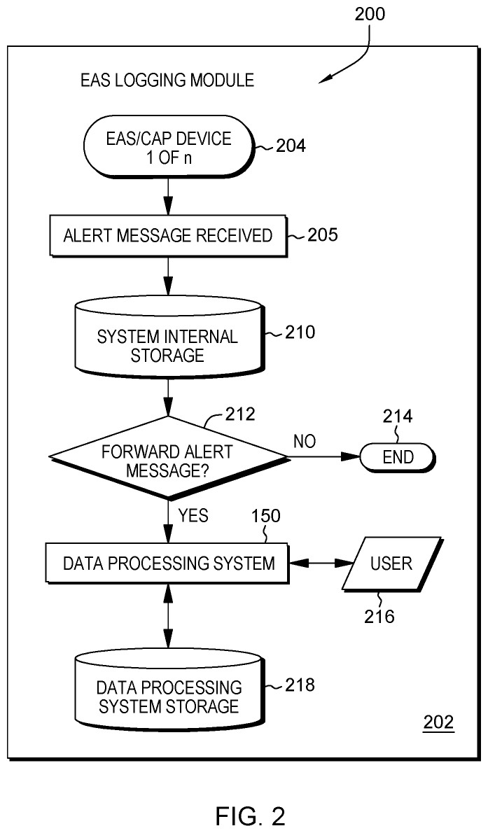

FIG. 2 is a modified flow diagram 200 of one example of operation of an EAS Logging Module 202 of the data processing system (150, FIG. 1) for monitoring and managing EAS devices, in accordance with one or more aspects of the present disclosure.

The EAS Logging Module provides filtering and sorting features of basic EAS alert data; alerts decoded, forwarded, and originated, event codes, Federal Information Processing Standard (FIPS) codes, Originators, EAS Station IDs, and Date/Time for the simplest types of overall report generation.

The EAS/CAP devices (collectively, 204) will from time to time receive alert messages 205. All alert messages are recorded on the EAS/CAP systems' internal storage 210. Based on a given EAS/CAP device's configuration, alert messages are selectively forwarded, inquiry 212, “forward alert message?”, to the data processing system 150. If the alert message is not to be forwarded to the data processing system, a “no” answer to inquiry 212, then operation of the EAS Logging Module ends with regard to the present alert message. If the alert message is to be forwarded, a “yes” answer to inquiry 212, then the alert message is forwarded to the data processing system 150. The processing system stores the alert messages in its data processing system storage 218 with the associated metadata reflecting the specific EAS/CAP device which sent the message.

A user 216 is able to recall the messages from the database using, for example, a series of filters and selectors for data retrieval and thereby is able to export the collected and filtered data in any number of formats. Examples include, but are not limited to, test file (.txt), comma-separated values (.csv), portable document format (.pdf), and direct printing through the user interface.

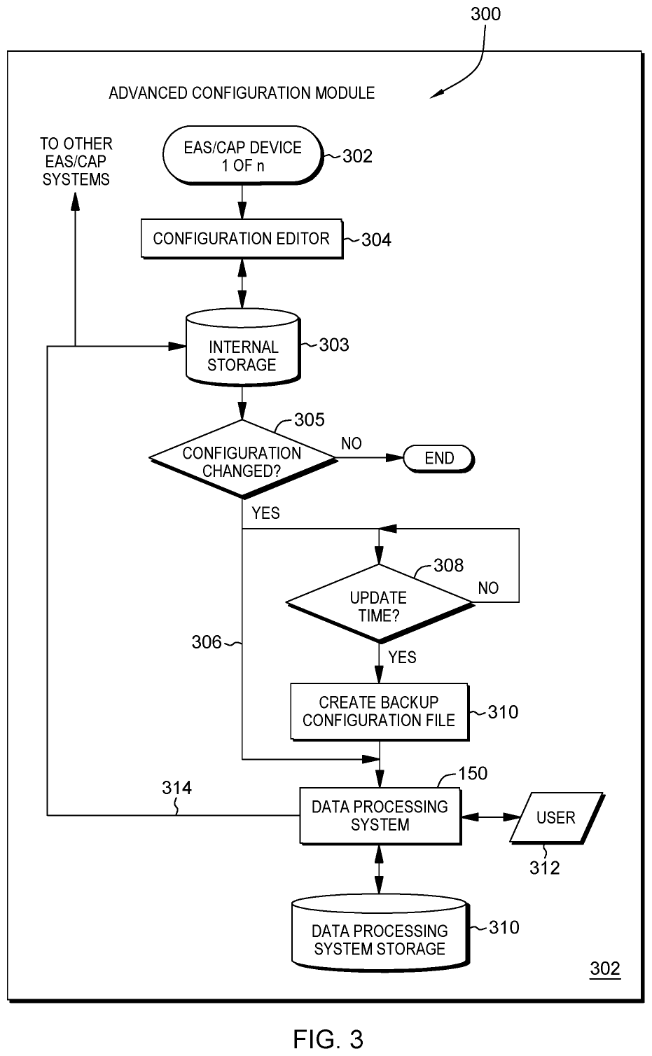

FIG. 3 is a modified flow diagram 300 of one example of operation of an Advanced Configuration Module 302 of the data processing system (150, FIG. 1), in accordance with one or more aspects of the present disclosure.

In one embodiment, the Advanced Configuration Module (ACM) significantly enhances device management, enabling users to review, compare and edit configuration settings directly within the user interface, allowing complex configuration comparisons and easy modifications. Using the ACM configuration files, software updates, or rollbacks on a single or multiple EAS devices can be performed remotely saving a substantial amount of time. Test releases and mass updates can be done quickly without having to individually deal with each device greatly reducing manpower requirements and increasing reliability.

An operator of an EAS/CAP device 302 may from time to time exact changes to the configuration of the device using a Configuration Editor 304 whereby an internally stored 303 configurations may be recalled and modified.

If the current configuration is changed, inquiry 305 (“configuration changed?”), the EAS/CAP system will signal a change, a “yes” answer to inquiry 305, as a message 306 was made to the data processing system 150 and invoke a timer monitoring a preset Update Time. When the time is met, a “yes” answer to inquiry 308 (“update time?”), the EAS/CAP device will Create a Backup Configuration File 310 and transfer the file to the Processing System 150 for retention in the Data Processing System Storage 310.

A data processing system user 312 can retrieve stored Configuration Files and pass them back to the same or any other EAS/CAP Device as Configuration Update 314 messages. The data processing system is capable of accessing, viewing, and/or comparing any of the Configuration Files in addition to editing, renaming, and storing them in the database (115, FIG. 1) for use on any single or multiple EAS/CAP Devices.

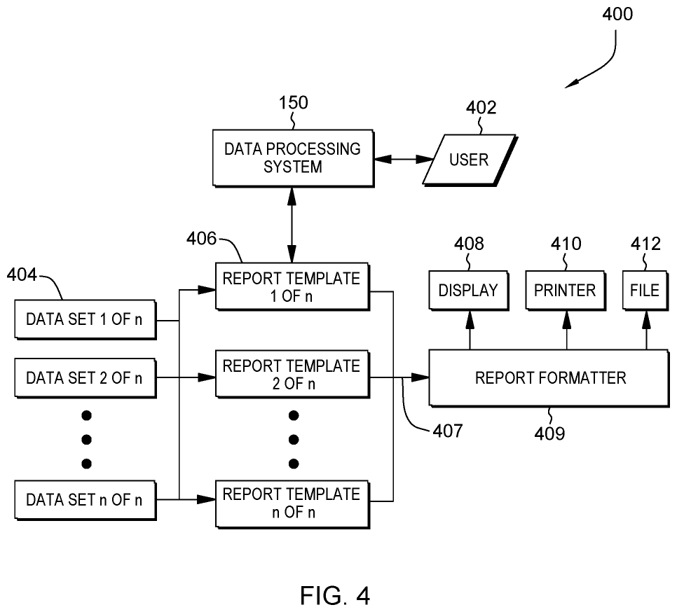

FIG. 4 is a modified flow diagram 400 of one example of operation of an Advanced Reporting Module 402 of the data processing system (150, FIG. 1), based on the EAS Logging Module of FIG. 2, in accordance with one or more aspects of the present disclosure.

The Advanced Reporting Module requires the EAS Logging Module and expands the level and detail of reporting beyond the basic reports of the EAS Logging Module. Additional reporting features include, for example: date ranges, filtering, sorting, histograms, charts and calendars. Customizable report templates may be saved for easy recall and generation of new reports following a user-defined set of criteria, say weekly, or monthly reports by region or group, or combine information to assemble an EAS Test Reporting System (ETRS) spreadsheet—greatly streamlining this conventionally labor-intensive process.

The data processing system 150 stores various amounts of information in multiple Data Set forms, for example, Data Set 404. One or more of these data sets can be queried to fill in various information within multiple Report Templates, for example, Reporting Template 406.

When Data Processing System User 402 requests a report template, the data collected and made available 407 to the Report Formatter 409. The Report Formatter's report role is to present the reported information defined in the selected Report Template in one or more ways as selected by the user. These may be, for example, one or more of the following: to a Display 408 device (e.g., computer monitor, projector, etc.), to a Printer 410 or saved as a File 412.

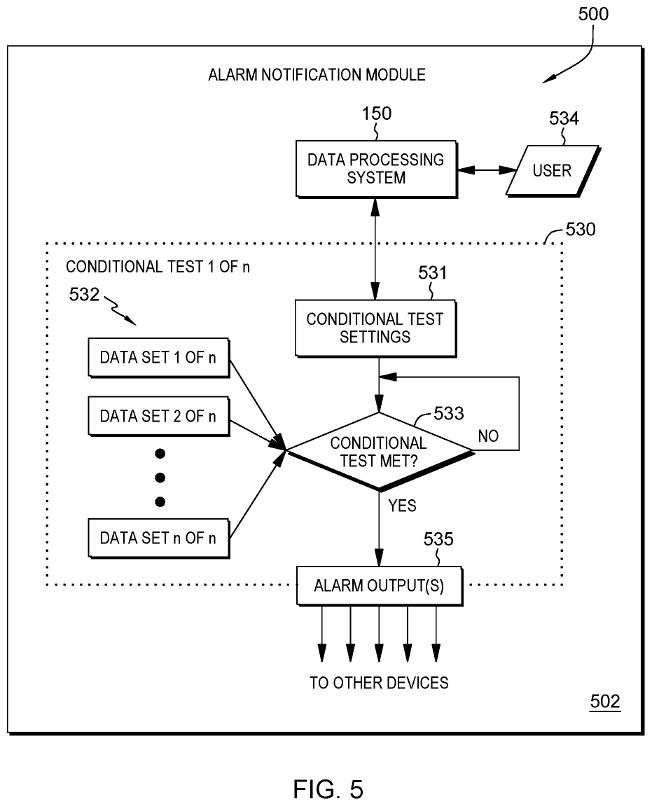

FIG. 5 is a modified flow diagram 500 of one example of the operation of an Alarm Notification Module 502, based on the EAS Logging Module of FIG. 2, of the data processing system (150, FIG. 1) for monitoring and managing EAS devices, in accordance with one or more aspects of the present disclosure.

Monitoring data for potential problems with EAS devices is the purvey of the Alarm Notification Module. The EAS Logging Module is required as the means to gather the necessary data. Setting customizable notifications regarding any number of parameters, fault conditions, changes in overall health indicators, access, configuration changes, a nearly unlimited number of parameters of alarms can be assigned. Each notification may be sent in a variety of manners; via e-mails, SMS messages, and/or on-screen displays, and a consolidated Simple Network Management Protocol (SNMP) Management Information Base (MIB) from a single source rather than from hundreds of individual devices streamlines interfacing with other alarm notification tools.

Data processing system 150 stores various amounts of information in multiple Data Set 532 forms. One or more of these data sets can be queried to determine various conditions a data processing system user 534 may set within the Conditional Test Setting 531. The Condition Test Met will continually test for the preset values and, when the conditions are met (a “yes” answer to inquiry 533), it will send a message to the Alarm Output 535 for communications to one or more devices.

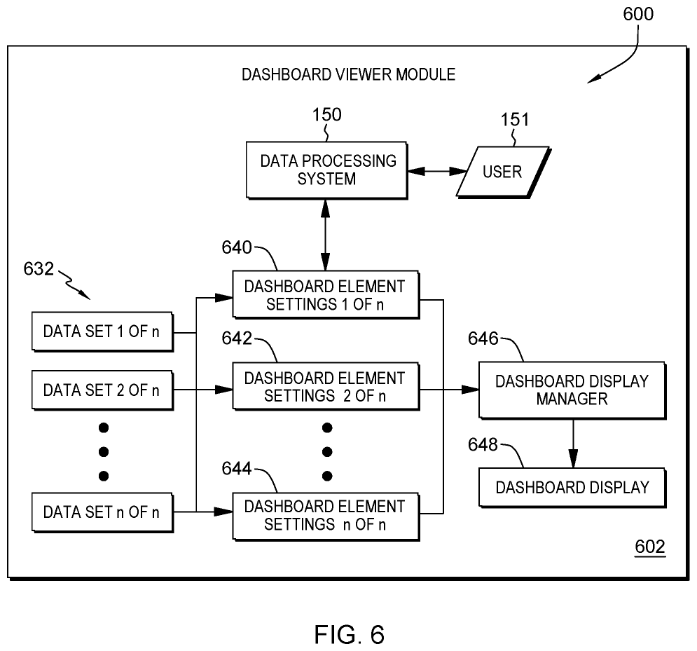

FIG. 6 is a modified flow diagram 600 of one example of the operation of a Dashboard Viewer Module 602, based on the EAS Logging Module of FIG. 2, of the data processing system 150 for monitoring and managing EAS devices, in accordance with one or more aspects of the present disclosure.

Visualization tools provide customizable information displays, for example, dashboard views for each user or group. Dashboards include items such as lists/tabular data, maps with data pins or shaded/affected areas. Rollover/mouse-over information provides, for example, device name, monitoring source status and last EAS alert information. With the unique browser integration, users can directly access the EAS device within the same screen. This is very useful when checking real-time information or making changes directly on a device. Using the Dashboard Viewer Module each user can see what is most important to them.

The data processing system 150 stores various amounts of information in multiple Data Set 632 forms. One or more of these data sets can be queried using a Dashboard Element Setting (DES) process, for example, DES 640, 642 or 644. The results are then available to the Dashboard Display Manager 646 for integration and presentation on the Dashboard Display 648.

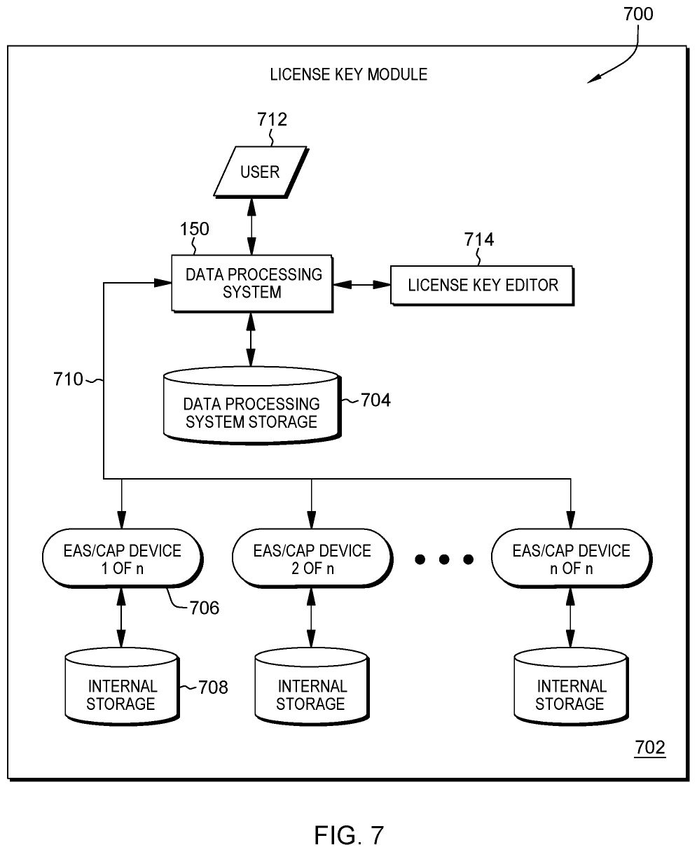

FIG. 7 is a modified flow diagram 700 of one example of the operation of a License Key Module 702 of the data processing system 150 for monitoring and managing EAS devices, in accordance with one or more aspects of the present disclosure.

Features may be enabled through license keys and managing these on each device can be very time-consuming. The License Key Module manages and automates this process providing a unique global view of license keys, even enabling users to remotely enable/disable licensed features and manage license keys across the entire environment.

Each EAS/CAP device is assigned attributes using a licensing method to enable/disable specific features. These “keys” to the EAS/CAP device features are stored in the EAS/CAP Internal Storage, for example, internal storage 708. The EAS/CAP device communicates to the data processing system 150 over a bi-directional communications link 710 a data table of enabled or disabled features. A user 712 can use the License Key Editor 714 to edit the table to enable or disable any of the features for one or several EAS/CAP devices and communicate the updated state to each EAS/CAP device.

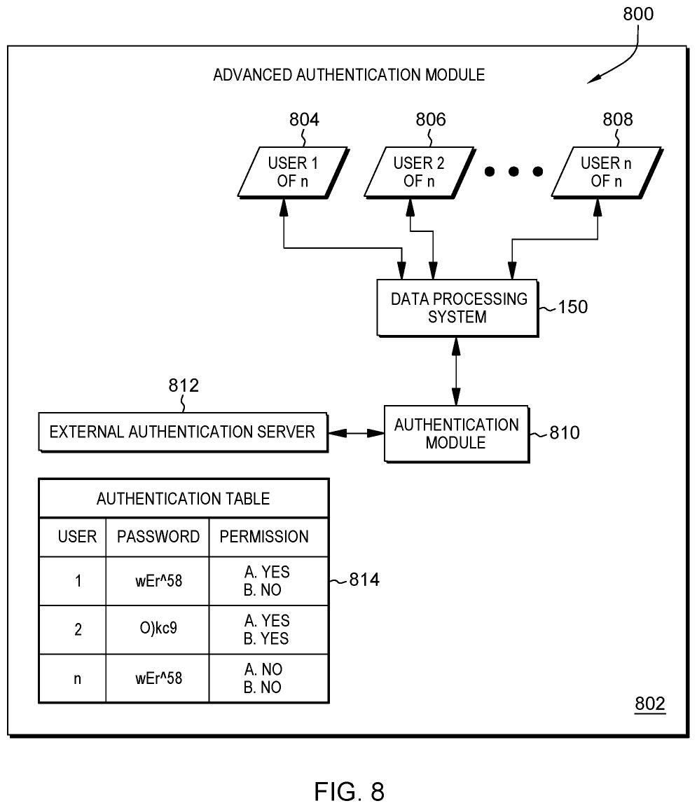

FIG. 8 is a modified flow diagram 800 of one example of the operation of an Advanced Authentication Module 802 of the data processing system 150 for monitoring and managing EAS devices, in accordance with one or more aspects of the present disclosure.

The Advanced Authentication Module enables the system to support (e.g., via Lightweight Directory Access Protocol (LDAP) or Remote Authentication Dial-In User Service (RADIUS)) authentication for centralized username and password management while certain permissions are maintained.

An External Authentication Server 812 provides centralized authentication, authorization and accounting of all users, for example, users 804, 806 and 808. This is shown as a simplified table labeled Authentication Table 814 in FIG. 8. The Authentication Module communicates with the External Authentication Server to present this information to the data processing system 150 allowing user controls to be externally set outside the data processing system itself.

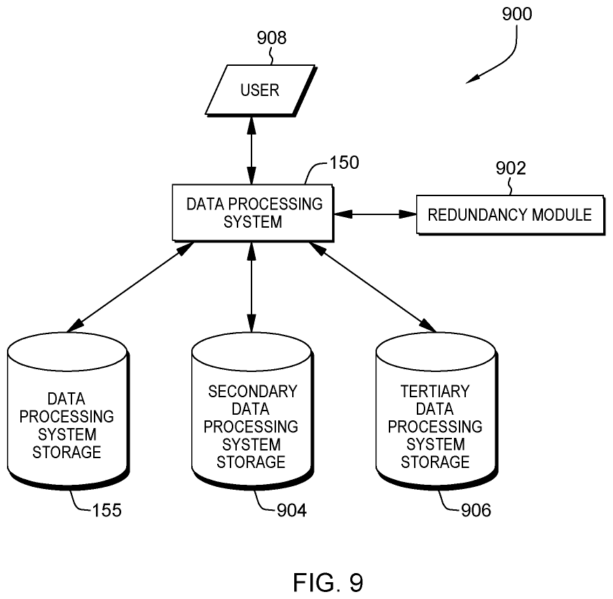

FIG. 9 is a block diagram 900 of one example of a Redundancy Module 902 as part of the data processing system 150 for monitoring and managing EAS devices, in accordance with one or more aspects of the present disclosure.

The Redundancy Module provides a secondary instance of the database to prevent a single point of failure. All data is, for example, mirrored on secondary data processing system storage 904 and, in one example, on tertiary data processing system storage 906 and automated failover is performed using a separate ‘watchdog’ application (not shown) to monitor and determine a need to switch operations between databases. Also, an administrator can force a manual changeover of the active server for maintenance or testing purposes. When the active server is changed, clients are automatically connected to the active server with no interaction necessary.

As noted, the data processing system 150, in one embodiment, hosts a Redundancy Module 902, which allows multiple storage systems to be used as secondary data processing system storage 904 and tertiary data processing system storage 906 as shown. The Redundancy Module control setting are performed through actions of the user 908.

Certain embodiments herein may offer various technical computing advantages involving computing advantages to address problems arising in the realm of computer networks. Particularly, computer networks operating to monitor and manage EAS/CAP devices. Embodiments herein can include monitoring by the system a status of the EAS devices, the status relating to configuration settings and updates to software and firmware for the EAS devices. Embodiments herein can include aggregating by the system government required compliance logs for the EAS devices, resulting in aggregated compliance logs. Embodiments herein can include generating one or more reports regarding the EAS devices with assistance from the system, wherein the one or more reports comprise a consolidated compliance report for providing to one or more government agencies, the consolidated compliance report comprising the aggregated compliance logs. Embodiments herein can include identifying by the system one or more status changes of the EAS devices, and notifying by the system at least one designated receiver of the one or more status changes. Various decision data structures can be used to drive artificial intelligence (AI) decision making, such as decision data structure that intelligently monitors and updates EAS/CAP devices, for example, configuration updates. Decision data structures as set forth herein can be updated by machine learning so that accuracy and reliability is iteratively improved over time without resource consuming rules intensive processing. Machine learning processes can be performed for increased accuracy and for reduction of reliance on rules-based criteria and thus reduced computational overhead. For enhancement of computational accuracies, embodiments can feature computational platforms existing only in the realm of computer networks such as artificial intelligence platforms, and machine learning platforms. Embodiments herein can employ data structuring processes, e.g. processing for transforming unstructured data into a form optimized for computerized processing. Embodiments herein can examine data from diverse data sources such as data sources that process radio signals for location determination of users. Embodiments herein can include artificial intelligence processing platforms featuring improved processes to transform unstructured data into structured form permitting computer-based analytics and decision making. Embodiments herein can include particular arrangements for both collecting rich data into a data repository and additional particular arrangements for updating such data and for use of that data to drive artificial intelligence decision making.

In one embodiment, a cognitive computer system performs one or more of the functions herein. In general, the term “cognitive computing” (CC) has been used to refer to new hardware and/or software that mimics the functioning of the human brain and helps to improve human decision-making, which can be further improved using machine learning. In this sense, CC is a new type of computing with the goal of more accurate models of how the human brain/mind senses, reasons, and responds to stimulus. CC applications link data analysis and adaptive page displays (AUI) to adjust content for a particular type of audience. As such, CC hardware and applications strive to be more effective and more influential by design.

Some common features that cognitive systems may express include, for example: ADAPTIVE—they may learn as information changes, and as goals and requirements evolve. They may resolve ambiguity and tolerate unpredictability. They may be engineered to feed on dynamic data in real time, or near real time; INTERACTIVE—they may interact easily with users so that those users can define their needs comfortably. They may also interact with other processors, devices, and Cloud services, as well as with people; ITERATIVE AND STATEFUL—they may aid in defining a problem by asking questions or finding additional source input if a problem statement is ambiguous or incomplete. They may “remember” previous interactions in a process and return information that is suitable for the specific application at that point in time; and CONTEXTUAL—they may understand, identify, and extract contextual elements such as meaning, syntax, time, location, appropriate domain, regulations, user's profile, process, task and goal. They may draw on multiple sources of information, including both structured and unstructured digital information, as well as sensory inputs (e.g., visual, gestural, auditory and/or sensor-provided).

In a first aspect, disclosed above is a method. The method includes providing a system, the system including processor(s) in communication with memory(ies) storing instructions for execution by the processor(s), the instructions enabling monitoring and assisting with managing Emergency Alert System/Common Alerting Protocol (EAS/CAP) devices, and monitoring by the system a status of the EAS/CAP devices, the status relating to configuration settings and updates to software and firmware for the EAS/CAP devices. The method further includes aggregating by the system government required compliance logs for the EAS/CAP devices, resulting in aggregated compliance logs, and generating report(s) regarding the EAS/CAP devices with assistance from the system, the report(s) including a consolidated compliance report for providing to government agency(ies), the consolidated compliance report including the aggregated compliance logs.

In one example, the method may further include, for example, storing by the system data related to the status of the plurality of EAS/CAP devices, and filtering and sorting the data with assistance from the system. In another example, the method may further include, for example, managing the configuration settings and updates to software and firmware for the EAS/CAP devices with assistance from the system. In another example, the method may further include, for example, customizable report templates for use in the generating. In another example, the method may further include, for example, identifying by the system one or more status changes of the plurality of EAS/CAP devices, and notifying by the system designated receiver(s) of the status change(s). In another example, the method may further include, for example, customizing graphical user interface(s) (GUI(s)) information display with assistance of the system.

In one example, the method of the first aspect may further include, for example, managing, with assistance of the system, license key(s) for use of aspect(s) (e.g., Modules) of the system.

In one example, the method of the first aspect may further include, for example, authenticating user identification and managing passwords with assistance of the system.

In one example, the method of the first aspect may further include, for example, database(s) storing the data. The method may further include, for example, creating by the system secondary instance(s) of the database(s), and monitoring by the system for failure(s) of the database(s) and failing over to the secondary instance(s) when at least one of the failure(s) occurs.

In a second aspect, disclosed above is a system. The system includes processor(s), and memory(ies) in communication with the processor(s), the memory(ies) storing instructions for execution by the processor(s), the instructions enabling a method of monitoring and assisting with managing Emergency Alert System/Common Alerting Protocol (EAS/CAP) devices, the processor(s) and the memory(ies) with the instructions stored is a system. The method further includes monitoring by the system a status of the EAS/CAP devices, the status relating to configuration settings and updates to software and firmware for the EAS/CAP devices, aggregating by the system government required compliance logs for the EAS/CAP devices, resulting in aggregated compliance logs, and generating report(s) regarding the EAS/CAP devices with assistance from the system, the report(s) may include a consolidated compliance report for providing to government agency(ies), the consolidated compliance report includes the aggregated compliance logs.

In one example, the system may further include, for example, storing by the system data related to the status of the EAS/CAP devices, and filtering and sorting the data with assistance from the system. The system may further include, for example, managing the configuration settings and updates to software and firmware for the EAS/CAP devices with assistance from the system. In one example, the system may further include, for example, customizable report templates for use in the generating. In one example, the system may further include, for example, identifying by the system status change(s) of the EAS/CAP devices, and notifying by the system designated receiver(s) of the status change(s). In one example, the system may further include, for example, customizing graphical user interface(s) (GUI(s)) information display with assistance of the system.

In one example, the system of the second aspect may further include, for example, managing, with assistance of the system, license key(s) for use of aspect(s) (e.g., Modules) of the system.

In one example, the system of the second aspect may further include, for example, authenticating, with assistance of the system, user identification and managing passwords.

In one example, the system of the second aspect may further include, for example, database(s) storing the data. The method may further include, for example, creating by the system secondary instance(s) of the database(s), and monitoring by the system for failure(s) of the database(s) and failing over to the secondary instance(s) when at least one of the failure(s) occurs.

In a third aspect, disclosed above is a computer program product. The computer program product includes a non-transitory storage medium readable by processor(s), the non-transitory storage medium storing instructions for execution by the processor(s) for performing a method of monitoring and assisting with managing Emergency Alert System/Common Alerting Protocol (EAS/CAP) devices. The method includes monitoring by the system a status of the EAS/CAP devices, the status relating to configuration settings and updates to software and firmware for the EAS/CAP devices, aggregating by the system government required compliance logs for the EAS/CAP devices, resulting in aggregated compliance logs, and generating report(s) regarding the EAS/CAP devices with assistance from the system, the report(s) includes a consolidated compliance report for providing to government agency(ies), the consolidated compliance report includes the aggregated compliance logs.

In one example, the method of the computer program product may further include, for example, storing by the system data related to the status of the EAS/CAP devices, and filtering and sorting of data with assistance from the system. In one example, the method may further include, for example, managing the configuration settings and updates to software and firmware for the EAS/CAP devices with assistance from the system. In one example, the system may further include, for example, customizable report templates for use in the generating. In one example, the method may further include, for example, identifying by the system status change(s) of the EAS/CAP devices, and notifying by the system designated receiver(s) of the status change(s). In one example, the method may further include, for example, customizing graphical user interface(s) (GUI(s)) information display with assistance of the system.

In one example, the method of the computer program product of the third aspect may further include, for example, managing, with assistance of the system, license key(s) for use of aspect(s) (e.g., Modules) of the system.

In one example, the method of the computer program product of the third aspect may further include, for example, authenticating user identification and managing passwords with assistance of the system.

In one example, the system of the computer program product of the third aspect may further include, for example, database(s) storing the data; and, the method of the computer program product of the third aspect may further include, for example, creating by the system secondary instance(s) of the database(s), and monitoring by the system for failure(s) of the database(s) and failing over to the secondary instance(s) when at least one of the failure(s) occurs.

EAS Management, in accordance with the present disclosure, provides, for example, a single aggregation of all EAS devices and provides, for example, information and control to all users throughout an enterprise with one secure login. Customizable User Interfaces (e.g., customized dashboards, tables and screen layouts) display information specific to individual job responsibilities (e.g., engineering, legal, compliance, etc.). Highly Configurable User and Permissions Settings provide full functionality and access to specific individuals or groups, while limiting access/control to others. Viewing and Interacting with all EAS devices within a single user interface includes, for example, seeing the entire network assures all sites are operating properly or quickly spot issues while providing SME's fast access to make any necessary corrections. Master Configuration Management reduces manpower and errors by storing/retrieving all configuration files allowing only approved configuration setting to be pushed to single or groups of EAS devices. Alert Message Logging/Reporting tracks EAS-related information from a single user interface to create customized reports for compliance/inventory management. Automatic and Manual EAS/CAP Device Registration quickly builds connections and data exchanges with “Trust Circle” approvals ensuring only those devices are included. Software Update Management reduces manpower requirements by managing software updates directly from the user interface, eliminating even “virtual visits” to each device. Master License Key Management enables/disables specific features selectively or universally to control functions of a single or groups of devices. System Health Monitoring's unique message exchange assures devices are operating at peak performance by, for example, identifying potential issues early. Alarm Notification creates conditional alarms with message notifications and access to external monitoring systems from a single point, rather than hundreds of separate sites. High Scalability provides management from 1 to 1000's of devices and installs specific modules befitting the requirements. High-performance SQL Database with Optional Hot-Swap Redundancy provides the ability to store, view and archive data in a secure, reliable and industry-standard database with options to mirror data and monitor up-time performance and support third-party data access.

The corresponding structures, materials, acts, and equivalents of all means or step plus function elements in the claims below, if any, are intended to include any structure, material, or act for performing the function in combination with other claimed elements as specifically claimed. The description of one or more aspects of one or more aspects has been presented for purposes of illustration and description, but is not intended to be exhaustive or limited to the invention in the form disclosed. Many modifications and variations will be apparent to those of ordinary skill in the art without departing from the scope and spirit of one or more aspects. The embodiment was chosen and described in order to best explain the principles of the one or more aspects and the practical application, and to enable others of ordinary skill in the art to understand the one or more aspects for various embodiments with various modifications as are suited to the particular use contemplated.

1. A method of monitoring and managing Emergency Alert System/Common Alerting Protocol (EAS/CAP) devices, the method comprising:
providing a system, the system comprising at least one processor in communication with at least one memory storing instructions for execution by the at least one processor, the instructions enabling monitoring and assisting with managing a plurality of EAS/CAP devices;
monitoring by the system a status of the plurality of EAS/CAP devices, wherein the status relates to configuration settings and updates to software and firmware for the plurality of EAS/CAP devices;
aggregating by the system government required compliance logs for the plurality of EAS/CAP devices, resulting in aggregated compliance logs; and
generating one or more reports regarding the plurality of EAS/CAP devices with assistance from the system, wherein the one or more reports comprise a consolidated compliance report for providing to one or more government agencies, the consolidated compliance report comprising the aggregated compliance logs.

2. The method of claim 1, further comprising:
storing by the system data related to the status of the plurality of EAS/CAP devices; and
filtering and sorting the data with assistance from the system.

3. The method of claim 2, further comprising managing the configuration settings and updates to software and firmware for the plurality of EAS/CAP devices with assistance from the system.

4. The method of claim 2, wherein the system further comprises customizable report templates for use in the generating.

5. The method of claim 2, further comprising:
identifying by the system one or more status changes of the plurality of EAS/CAP devices; and
notifying by the system at least one designated receiver of the one or more status changes.

6. The method of claim 2, further comprising customizing at least one graphical user interface (GUI) information display with assistance of the system.

7. The method of claim 1, further comprising managing, with assistance of the system, one or more license keys for use of one or more aspects of the system.

8. The method of claim 1, further comprising authenticating user identification and managing passwords with assistance of the system.

9. The method of claim 1, wherein the system further comprises at least one database storing the data, the method further comprising:
creating by the system at least one secondary instance of the at least one database; and
monitoring by the system for one or more failures of the at least one database and failing over to the at least one secondary instance when at least one of the one or more failures occurs.

10. A system for monitoring and managing Emergency Alert System/Common Alerting Protocol (EAS/CAP) devices, the system comprising:
at least one processor; and
at least one memory in communication with the at least one processor, the at least one memory storing instructions for execution by the at least one processor, the instructions enabling a method of monitoring and assisting with managing a plurality of EAS/CAP devices, the at least one processor and the at least one memory with the instructions stored comprising a system, the method comprising:
monitoring by the system a status of the plurality of EAS/CAP devices, wherein the status relates to configuration settings and updates to software and firmware for the plurality of EAS/CAP devices;
aggregating by the system government required compliance logs for the plurality of EAS/CAP devices, resulting in aggregated compliance logs; and
generating one or more reports regarding the plurality of EAS/CAP devices with assistance from the system, wherein the one or more reports comprise a consolidated compliance report for providing to one or more government agencies, the consolidated compliance report comprising the aggregated compliance logs.

11. The system of claim 10, further comprising:
storing by the system data related to the status of the plurality of EAS/CAP devices; and
filtering and sorting the data with assistance from the system.

12. The system of claim 11, further comprising managing the configuration settings and updates to software and firmware for the plurality of EAS/CAP devices with assistance from the system.

13. The system of claim 11, wherein the system further comprises customizable report templates for use in the generating.

14. The system of claim 11, further comprising:
identifying by the system one or more status changes of the plurality of EAS/CAP devices; and
notifying by the system at least one designated receiver of the one or more status changes.

15. The system of claim 11, further comprising customizing at least one graphical user interface (GUI) information display with assistance of the system.

16. The system of claim 10, further comprising managing, with assistance of the system, one or more license keys for use of one or more aspects of the system.

17. The system of claim 10, further comprising authenticating user identification and managing passwords with assistance of the system.

18. The system of claim 10, wherein the system further comprises at least one database storing the data, the method further comprising:
creating by the system at least one secondary instance of the at least one database; and
monitoring by the system for one or more failures of the at least one database and failing over to the at least one secondary instance when at least one of the one or more failures occurs.

19. A computer program product, comprising:
a non-transitory storage medium readable by at least one processor, the non-transitory storage medium storing instructions for execution by the at least one processor for performing a method of monitoring and assisting with managing Emergency Alert System/Common Alerting Protocol (EAS/CAP) devices, the method comprising:
monitoring by the system a status of the plurality of EAS/CAP devices, wherein the status relates to configuration settings and updates to software and firmware for the plurality of EAS/CAP devices;
aggregating by the system government required compliance logs for the plurality of EAS/CAP devices, resulting in aggregated compliance logs; and
generating one or more reports regarding the plurality of EAS/CAP devices with assistance from the system, wherein the one or more reports comprise a consolidated compliance report for providing to one or more government agencies, the consolidated compliance report comprising the aggregated compliance logs.

20. The computer program product of claim 19, wherein the method further comprises:
storing by the system data related to the status of the plurality of EAS/CAP devices; and
filtering and sorting of data with assistance from the system.

21. The computer program product of claim 20, wherein the method further comprises managing the configuration settings and updates to software and firmware for the plurality of EAS/CAP devices with assistance from the system.

22. The computer program product of claim 20, wherein the system further comprises customizable report templates for use in the generating.

23. The computer program product of claim 20, wherein the method further comprises:
identifying by the system one or more status changes of the plurality of EAS/CAP devices; and
notifying by the system at least one designated receiver of the one or more status changes.

24. The computer program product of claim 20, wherein the method further comprises customizing at least one graphical user interface (GUI) information display with assistance of the system.

25. The computer program product of claim 19, wherein the method further comprises managing, with assistance of the system, one or more license keys for use of one or more aspects of the system.

26. The computer program product of claim 19, wherein the method further comprises authenticating user identification and managing passwords with assistance of the system.

27. The computer program product of claim 19, wherein the system further comprises at least one database storing the data, the method further comprising:
creating by the system at least one secondary instance of the at least one database; and
monitoring by the system for one or more failures of the at least one database and failing over to the at least one secondary instance when at least one of the one or more failures occurs.
